(19) United States
(12) Patent Application Publication
(10) Pub. No.: US 2012/0169203 A1
(43) Pub. Date: Jul. 5, 2012

(54) LED LAMP

(76) Inventor: Tzung-Shiun Tsai, Kaohsiung (TW)

(21) Appl. No.: 12/983,320

(22) Filed: Jan. 2, 2011

(51) Int. Cl. H01K 1/30

(52) U.S. Cl. 313/116

(57) ABSTRACT

A lamp includes a hollow main body; an electrical circuit assembly disposed in the main body; an LED illumination assembly disposed in front of the electrical circuit assembly and electrically connected thereto; a diffuser disposed in front of the illumination assembly; a frame mounted on a forward end of the main body with the diffuser fitted therein; and a hollow protective cover shaped to enclose the electrical circuit assembly.

### BACKGROUND OF THE INVENTION

1. Field of Invention

The invention relates to lamps and more particularly to an LED (light emitting diode) lamp with improved characteristics including overheat protection.

2.Description of Related Art

Lamps are devices for illumination. It is understood that at higher power levels, the heat generated by a lamp may encounter too much thermal resistance to the ambient. Thus, the lamp may overheat and fail. Specifically, applying too much power to the lamp creates thermal gradients in the material that will cause cracks in the lamp body and possibly an explosion of a weakened lamp.

Heat sinks and/or cooling fins are conventional means for heat management of lamps. However, as far as the present inventor is aware, efficient transfer of heat generated by an energized lamp has not been made possible. Thus, the need for improvement still exists.

### SUMMARY OF THE INVENTION

It is therefore one object of the invention to provide a lamp comprising a hollow main body; an electrical circuit assembly disposed in the main body; an LED illumination assembly disposed in front of the electrical circuit assembly and electrically connected thereto; a diffuser disposed in front of the illumination assembly; a frame mounted on a forward end of the main body with the diffuser fitted therein; and a hollow protective cover shaped to enclose the electrical circuit assembly.

The above and other objects, features and advantages of the invention will become apparent from the following detailed description taken with the accompanying drawings.

### BRIEF DESCRIPTION OF THE DRAWINGS

FIG. 1 is a perspective view of a lamp according to a first preferred embodiment of the invention;

FIG. 2 is an exploded view of the lamp of FIG. 1;

FIG. 3 is a perspective view of a lamp according to a second preferred embodiment of the invention;

FIG. 4 is an exploded view of the lamp of FIG. 3;

FIG. 5 is a perspective view of the lamp of FIG. 3 to be fastened with a fastening device;

FIG. 6 is a perspective view of the lamp and the fastening device fastened together and mounted onto a ceiling;

FIG. 7 is a perspective view of the lamp of FIG. 3 to be fastened with a fastening device;

FIG. 8 is a perspective view of the lamp and the fastening device fastened together and mounted onto a ceiling;

FIG. 9 is a perspective view of the lamp of FIG. 3 to be fastened with two fastening devices;

FIG. 10 is a perspective view of the lamp and the fastening device 2 fastened together and mounted onto a ceiling;

FIG. 11 is a perspective view of the lamp of FIG. 3 to be fastened with a fastening device;

FIG. 12 is a schematic longitudinal sectional view of the lamp and the fastening device fastened together and mounted in a ceiling; and

FIG. 13 is a block diagram of the thermo regulation device.

### DETAILED DESCRIPTION OF THE INVENTION

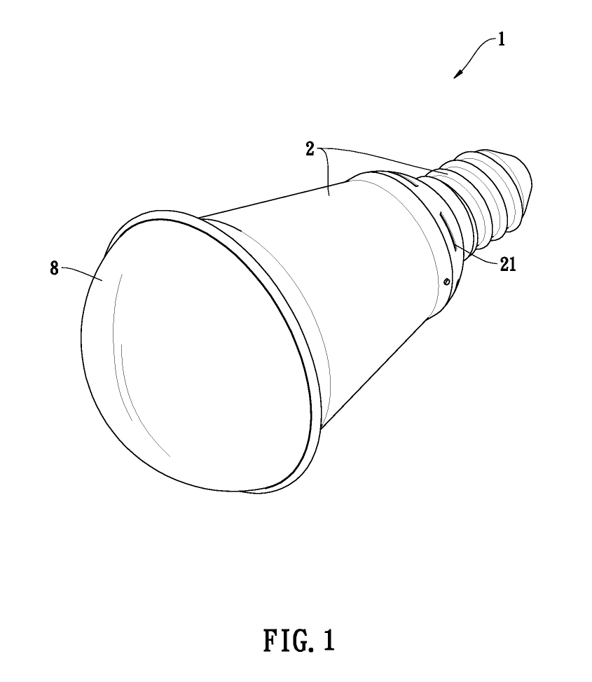

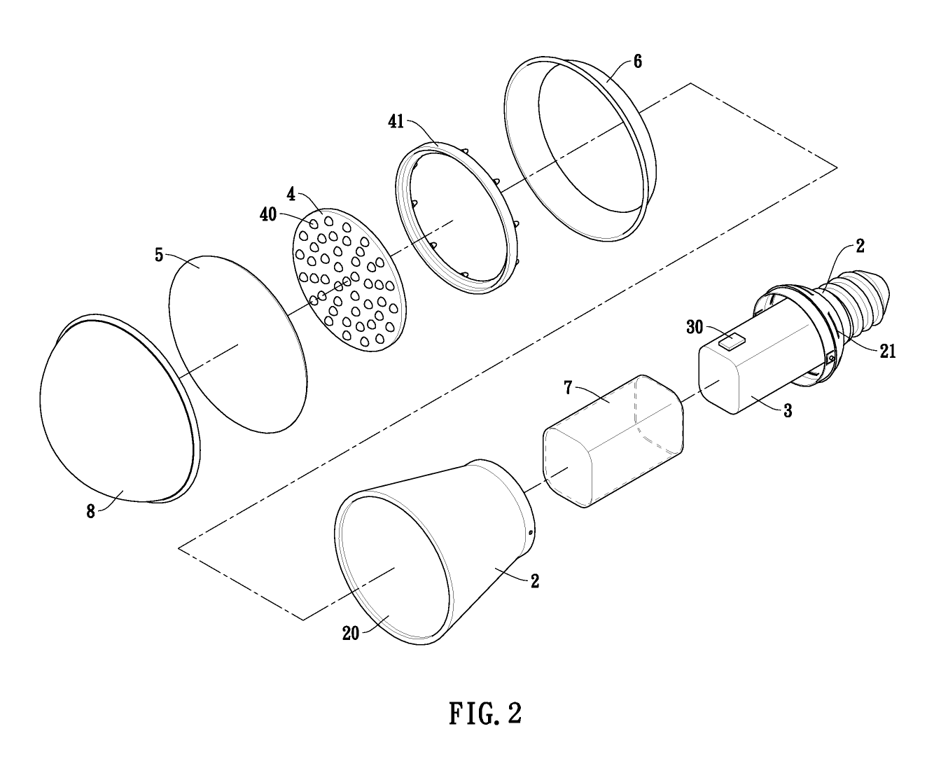

Referring to FIGS. 1 and 2, a lamp 1 in accordance with a first preferred embodiment of the invention comprises the following components as discussed in detail below.

A main body 2 comprises a plurality of equally spaced apart slits 21 on a conductive base portion for heat dissipation, and a hollow, truncated conic shade member 20. The main body 2 is formed by injection molding so as to reduce pollution in the manufacturing process.

A parallelepiped electrical circuit assembly 3 is secured to the base portion of the main body 2 to be electrically connected thereto and surrounded by the shade member 20. A thermo regulation device 30 is provided on the surface of the electrical circuit assembly 3 for measuring temperature of the lamp 1 and for preventing the electrical circuit assembly 3 from being overheated.

A disc shaped illumination assembly 4 comprises a plurality of LEDs (light emitting diodes) 40 mounted thereon, the LEDs 40 being electrically connected to the electrical circuit assembly 3, and an insulating ring 41 made of silicon rubber and fitted onto the illumination assembly 4. A diffuser 5 is provided in front of the illumination assembly 4 for rendering subtle effects of light emitted by the LEDs 40.

A truncated conic frame 6 is mounted on a forward end of the main body 2 with the diffuser 5 fitted therein. The frame 6 is made of optically transmissive material (i.e., transparent). A convex lens 8 is detachably secured to the frame 6 by snapping. A hollow protective cover 7 is shaped to enclose the electrical circuit assembly 3 for protection.

It is envisaged by the invention that a subtle light is emitted from the LEDs 40 through the lens 8 and light is also emitted through the frame 6. In brief, light is diffused rather than directional (i.e., forward direction).

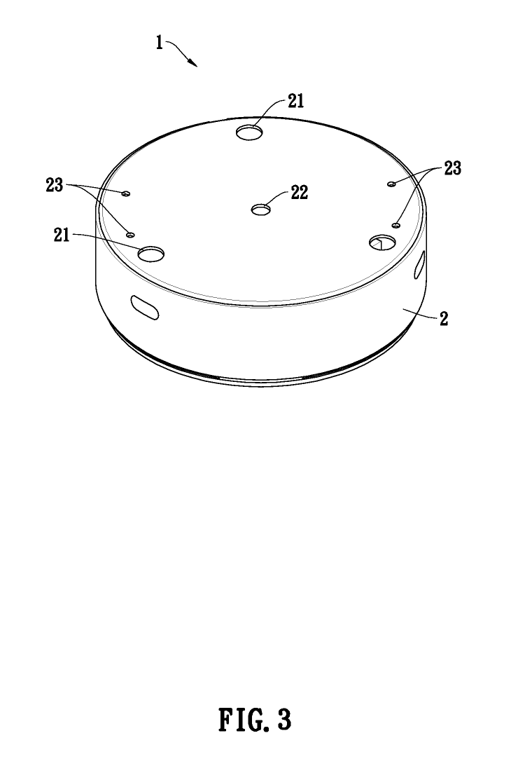

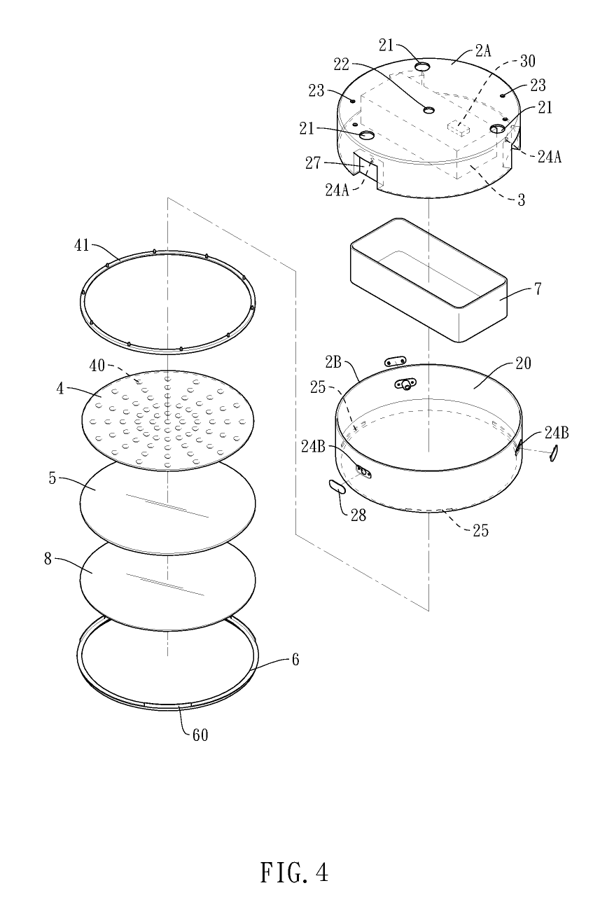

Referring to FIGS. 3 and 4, a cylindrical lamp 1 in accordance with a second preferred embodiment of the invention is shown. The characteristics of the second preferred embodiment are detailed below.

The lamp 1 comprises a cylindrical main body 2 comprising a cylindrical inner member 2A and a cylindrical outer member 2B. The inner member 2A comprises a plurality of equally spaced apart slits 21 on proximate to edge of a top for heat dissipation, a central hole 22 through the top, a plurality of apertures 23 proximate to edge of the top, a plurality of spaced apart rectangular cavities 27 on a skirt, and a plurality of holes 24A each disposed in the cavity 27.

The outer member 2B is a corresponding mating member of the inner member 2A and comprises a plurality of holes 24B each formed in a well (not numbered) on a skirt, the holes 24B being aligned with the holes 24A when the inner and outer members 2A, 2B assembled, a plurality of filling members 28 each fitted onto the well to make the skirt smooth, and a plurality of recesses 25 formed a bottom edge.

A parallelepiped electrical circuit assembly 3 is secured to the underside of the top of the inner member 2B to be electrically connected thereto. A thermo regulation device 30 is provided on the top surface of the electrical circuit assembly 3 for measuring temperature of the lamp 1 and for preventing the electrical circuit assembly 3 from being overheated.

A disc shaped illumination assembly 4 comprises a plurality of LEDs 40 mounted thereon, the LEDs 40 being electrically connected to the electrical circuit assembly 3, and an insulating ring 41 made of silicon rubber and fitted onto the illumination assembly 4. A diffuser 5 is provided below the illumination assembly 4 for rendering subtle effects of light emitted by the LEDs 40.

A ring-shaped frame 6 comprises a plurality of equally spaced apart latches 60 adapted to insert into the recesses 25 for securing the frame 6 to the bottom of the main body 2 and securing both the diffuser 5 and a lens 8 in front of the diffuser 5 to the frame 6 by snapping. A hollow protective cover 7 is shaped to enclose the electrical circuit assembly 3 for protection.

It is envisaged by the invention that a subtle light is emitted from the LEDs 40 through the lens 8. In brief, light is diffused rather than directional (i.e., forward direction).

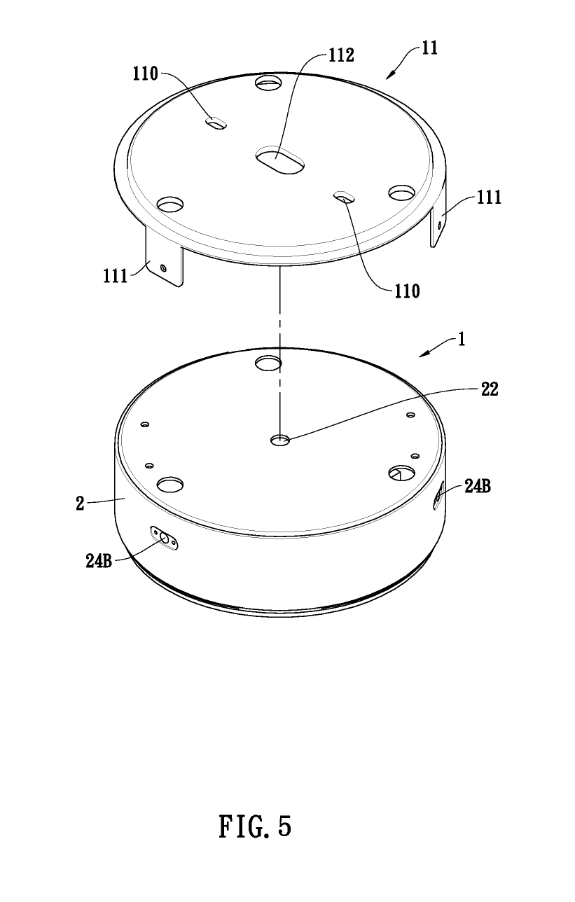

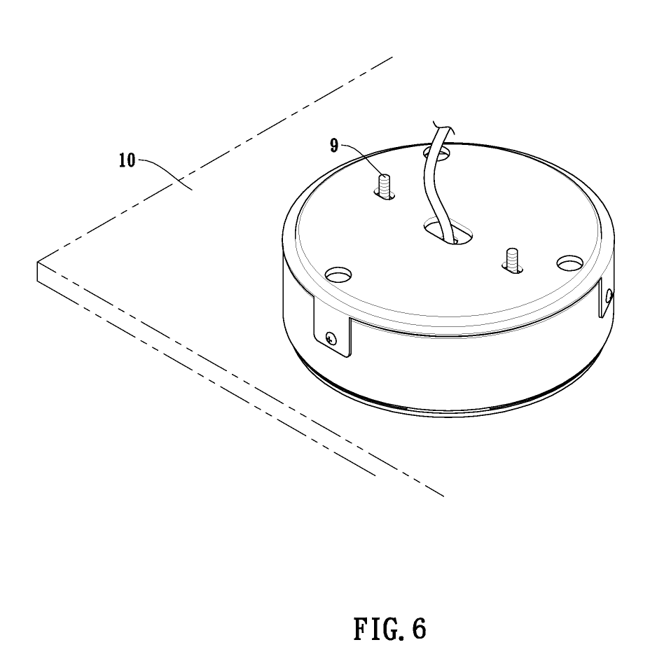

Referring to FIGS. 5 and 6 in conjunction with FIG. 4, the cylindrical lamp 1 in accordance with the second preferred embodiment of the invention can be installed in a first configuration as detailed below.

A disc shaped fastening device 11 comprises a central elongated opening 112, two opposite holes 110 spaced from both ends of the opening 112 respectively, and a plurality of equally spaced apart legs 111 depending downward, each leg 111 having a threaded hole (not numbered) therethrough.

A plurality of threaded fasteners (not numbered) are driven through the threaded holes of the legs 111 and the holes 24B, 24A to secure the fastening device 11, the outer member 2B, and the inner member 2A together. The fastening device 11 is disposed above the main body 2 by a distance. Thus, a plurality of threaded fasteners 9 may be driven through the holes 110 into a ceiling 10 to secure the lamp 1 to the ceiling 10. Note that the fasteners 9 are disposed through the holes 110 prior to the fastening of the lamp 1 and the ceiling 10. A wire (not numbered) is extended from an external power source (not shown) to the electrical circuit assembly 3 for supplying power thereto.

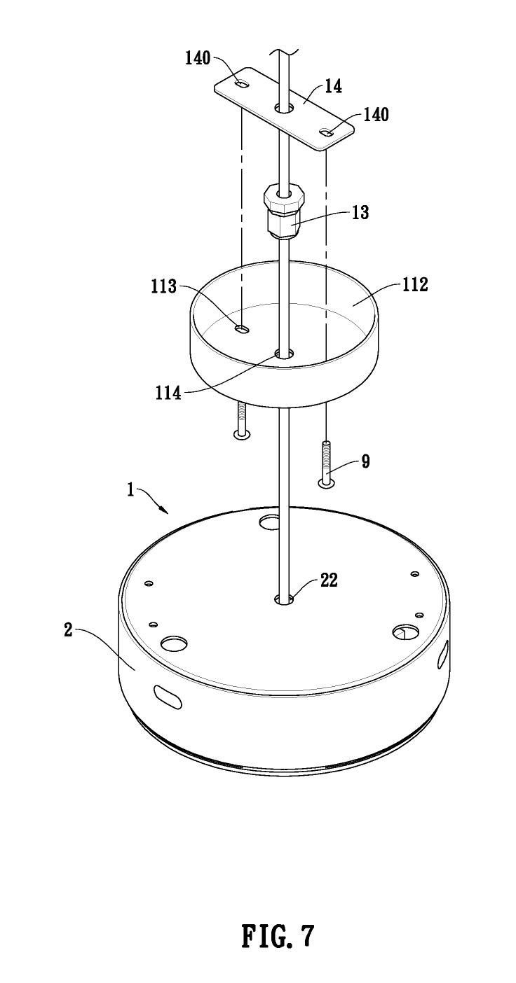

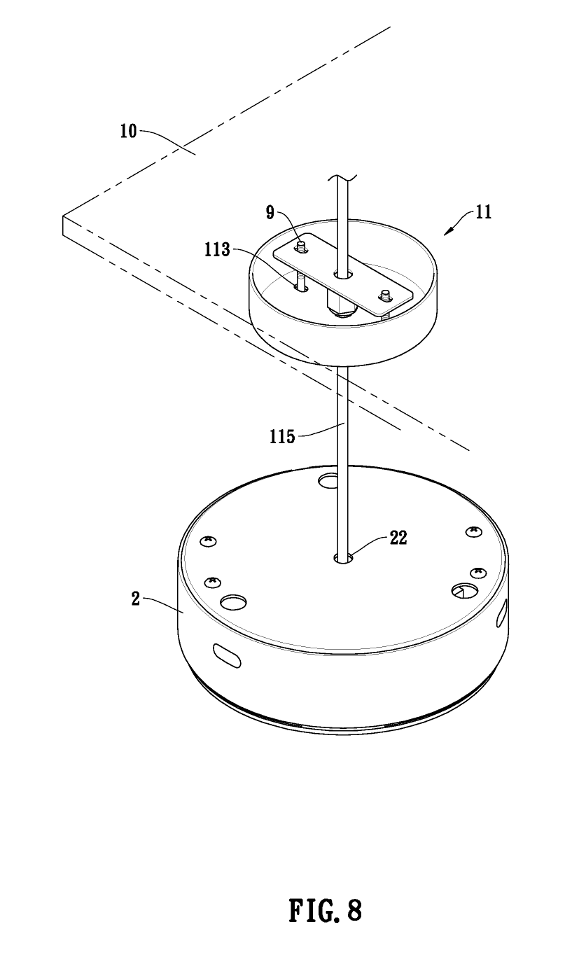

Referring to FIGS. 7 and 8 in conjunction with FIG. 4, the cylindrical lamp 1 in accordance with the second preferred embodiment of the invention can be installed in a second configuration as detailed below.

A fastening device 11 comprises a hollow cylindrical support 112 having an open top, a central opening 114 on the bottom of the support 112, and two opposite holes 113 aligned with the opening 114 therebetween. The support 112 is disposed on top of an inner surface of a ceiling 10. A wire 115 is inserted through the hole 22 and the ceiling. A spacer 13 is put on the wire 115 and rested upon the bottom of the support 112. A rectangular plate 14 has a hole (not numbered) with the wire 115 passing through. The plate 14 has two end holes 140. A plurality of threaded fasteners 9 are driven through the ceiling 10 and the holes 113, 140 to secure the ceiling 10 and the fastening device 11 together. Thus, the fastening device 11 is secured to top of the inner surface of a ceiling 10. Also, the lamp 1 is disposed below the ceiling 10 by a distance.

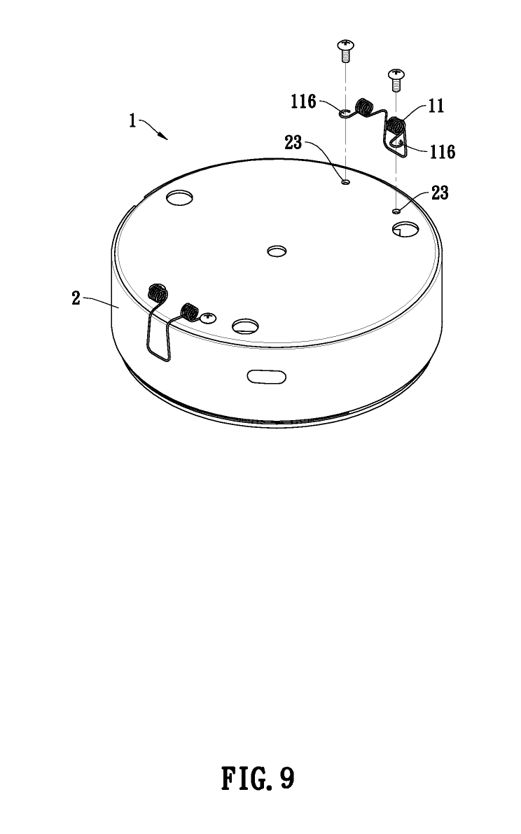

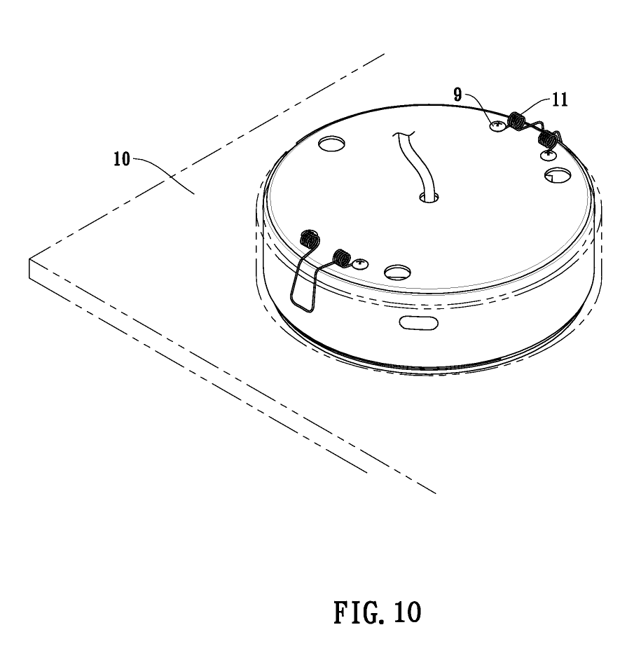

Referring to FIGS. 9 and 10 in conjunction with FIG. 4, the cylindrical lamp 1 in accordance with the second preferred embodiment of the invention can be installed in a third configuration as detailed below.

Two fastening devices 11 each is implemented as a U-shaped clip. The fastening device 11 comprises two curved ends 116 so that a plurality of threaded fasteners (not numbered) each may be driven through the curved end 116 into the aperture 23 to secure the fastening devices 11 and the lamp 1 together. Moreover, the fastening devices 11 may be pivoted about the covered ends 116 to secure the lamp 1 to a ceiling 10.

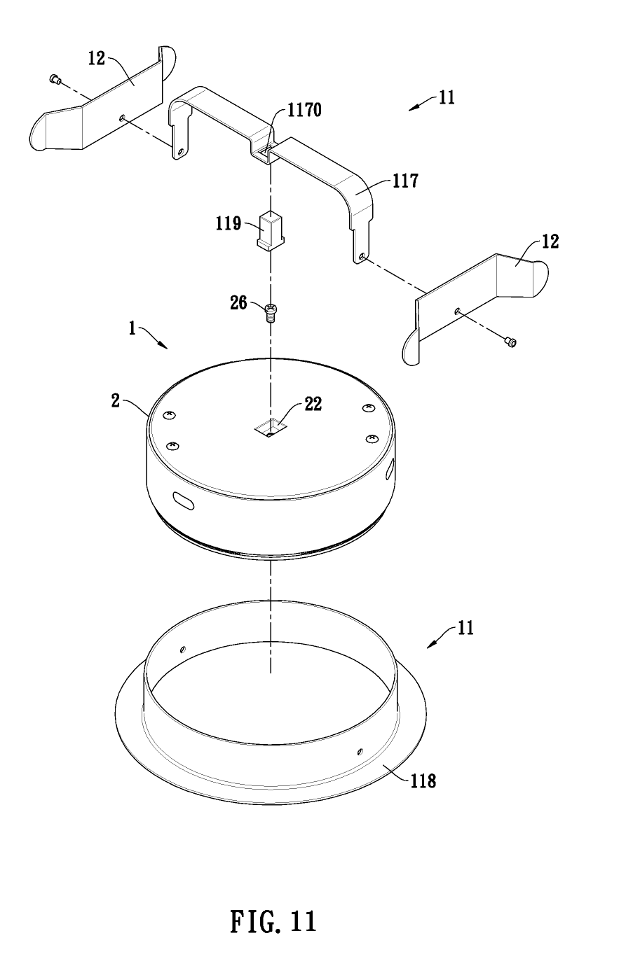

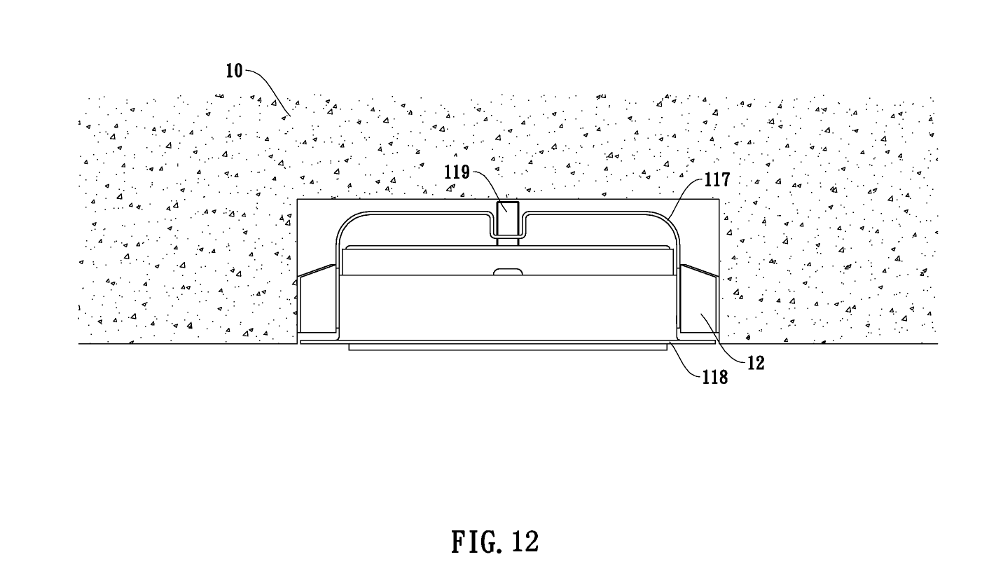

Referring to FIGS. 11 and 12 in conjunction with FIG. 4, the cylindrical lamp 1 in accordance with the second preferred embodiment of the invention can be installed in a fourth configuration as detailed below.

A fastening device 11 is disposed above the main body 2. A fastener 26 is used to secure the fastening device 11 to the top central hole 22. The fastening device 11 comprises an inverted U-shaped frame member 117 and a ring shaped frame element 118. A recess 1170 is formed on a center of the frame member 117. A snapping member 119 is disposed in the recess 1170. The snapping member 119 is snappingly secured to the fastener 26 so that the lamp 1 can be fastened in the frame element 118. A plurality of fastening elements (not numbered) are driven through two opposite clamping members 12, the frame member 117, and the frame element 118 to secure the lamp 1 to a ceiling 10.

For detaching the lamp 1 from the ceiling 10 for component replacement purpose or the like, an individual may push the lamp 1 upward. As a result, the snapping member 119 unfastens the lamp 1 and the fastener 26. Therefore, the individual may detach the lamp 1. After the replacement and disposing the lamp 1 in its original position, the individual may press the fastener 26 against the snapping member 119 to secure the lamp 1 and the fastening device 11 together.

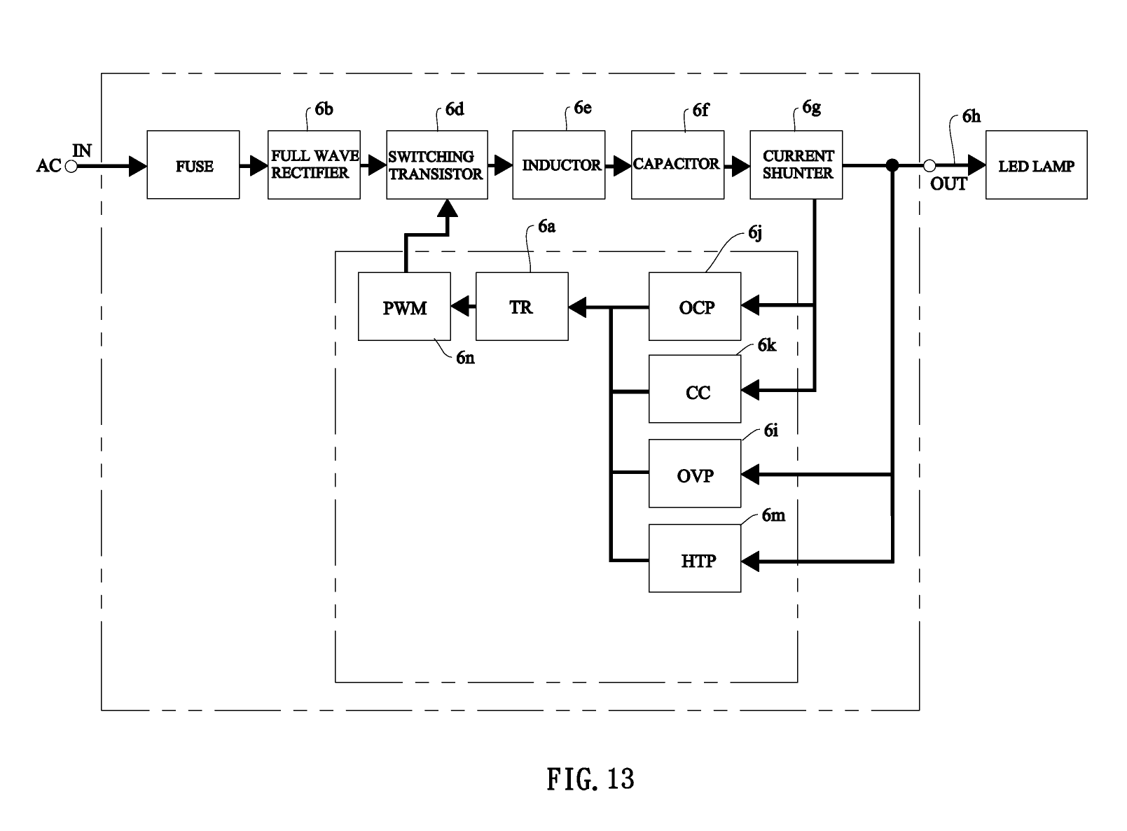

Referring to FIG. 13, the thermo regulation device 30 may operate as follows: External power (e.g., 100 to 240 volts AC) supplies to a full wave rectifier 6b via a fuse. Power is converted into DC by the full wave rectifier 6b to be used by a next stage. DC is further stepped down by a switching transistor 6d. In a next stage, an inductor (i.e., filter) 6e is employed to reduce a ripple DC voltage. In a next stage, a capacitor (i.e., filter) 6f is employed to further reduce the ripple DC voltage for smoothing purpose. In a next stage, a current shunt 6g is employed to direct one portion of DC current to a load (e.g., the LED lamp 1 of the first or second preferred embodiment discussed above), an overvoltage protection circuit 6i, and a high temperature protection circuit 6m. Moreover, the other portion of DC current is directed to an over current protection circuit 6j and a constant current circuit 6k. The above four circuits 6i, 6m, 6j, and 6k consist of a feedback compensation circuit which is in turn electrically to a thermo regulation circuit 6a in a next stage. In a final stage, a pulse width modulation circuit 6n is employed to modulate the pulse width of DC in the switching transistor 6d.

It is envisaged by the invention that the thermo regulation device can regulate output current to a constant value for lamp consumption in response to irregularities of the input AC. Thus, the lamp 1 can illuminate normally. Moreover, the thermo regulation device can keep temperature of the lamp 1 within predetermined limits. Thus, the lifetime of the lamp 1 can be increased.

While the invention has been described in terms of preferred embodiments, those skilled in the art will recognize that the invention can be practiced with modifications within the spirit and scope of the appended claims.

What is claimed is:

1. A lamp comprising:
a hollow main body comprising at least one opening for heat dissipation;
an electrical circuit assembly disposed in the main body;
an LED illumination assembly disposed in front of the electrical circuit assembly and electrically connected thereto;
a diffuser disposed in front of the illumination assembly;
a frame mounted on a forward end of the main body with the diffuser fitted therein; and
a hollow protective cover enclosing the electrical circuit assembly;
wherein the electrical circuit assembly extends longitudinally between an end of the hollow main body and the LED illumination assembly, and the hollow protective cover fully encloses longitudinal sides of the electrical circuit assembly.

2. The lamp of claim 1, wherein the frame is formed of optically transmissive material.

3. The lamp of claim 1, wherein the frame is a truncated cone.

4. The lamp of claim 1, further comprising a lens detachably secured to the frame.

5. The lamp of claim 4, wherein the lens is optically transmissive.

6. The lamp of claim 4, wherein the lens is convex.

7. The lamp of claim 1, further comprising a fastening device for fastening the lamp.

8. The lamp of claim 7, wherein the fastening device is a disc shaped member.

9. The lamp of claim 7, wherein the fastening device is a suspension member.

10. The lamp of claim 7, wherein the fastening device comprises two clips.

11. The lamp of claim 7, wherein the fastening device is a snapping assembly.

12. The lamp of claim 1, wherein the main body is formed by injection molding.

13. The lamp of claim 1, furthering comprising an insulating ring fitted onto the illumination assembly.

14. The lamp of claim 1, further comprising a thermo regulation device in the electrical circuit assembly.
